(19) United States
(12) Patent Application Publication
(10) Pub. No.: US 2012/0139282 A1
(43) Pub. Date: Jun. 7, 2012

(54) Combination Vehicle of Pickup and SUV

(76) Inventor: Shuguang Gu, Calgary (CA)

(21) Appl. No.: 13/199,727

(22) Filed: May 29, 2011

(30) Foreign Application Priority Data
Dec. 2, 2010 (CN) 201020637458.5

(51) Int. Cl. B60J 7/04; B60N 2/005

(52) U.S. Cl. 296/63; 296/99.1

(57) ABSTRACT

A new combination vehicle of pickup and SUV which comprising four major parts: sliding roofing back, foldable middle plate, side window glasses, and auto sliding track system. By changing their performances the vehicle is convertible from either pickup truck to SUV or vice versa. It combines features, functions and characteristics of both vehicles, and meets the needs of both vehicle drivers, and furthermore saves the space, energy and protects the environment.

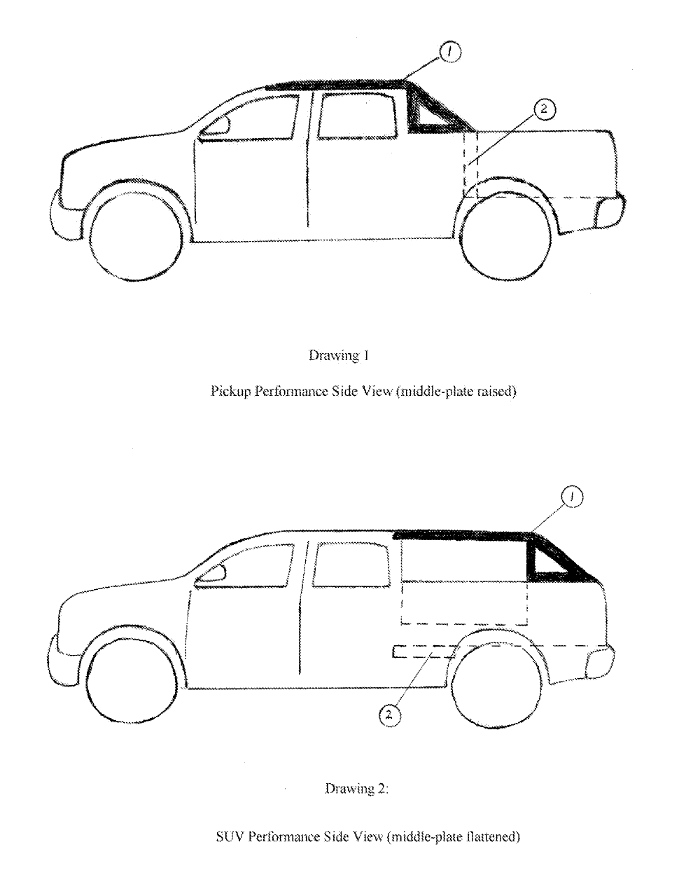

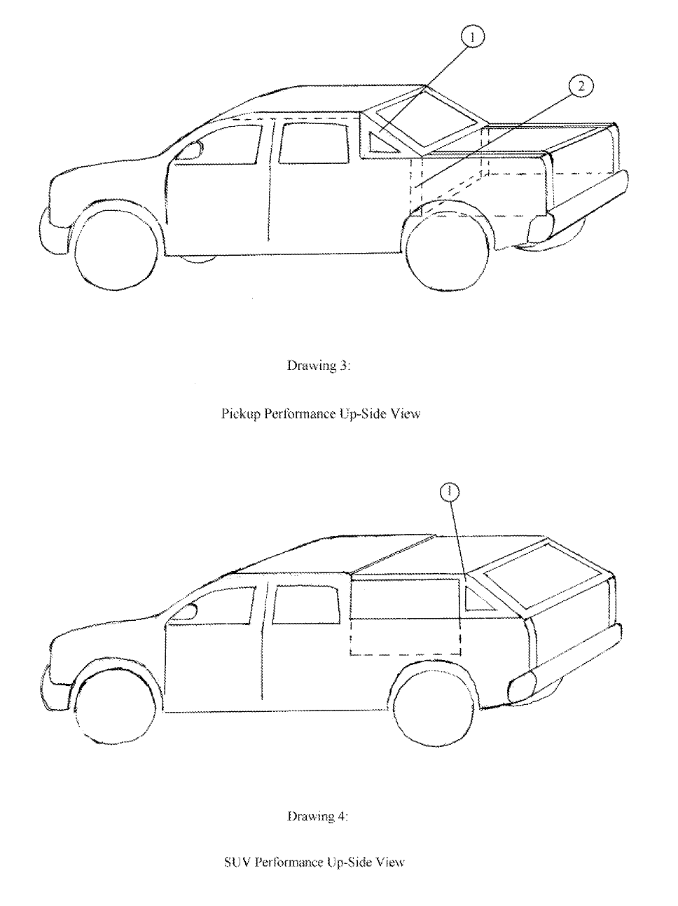

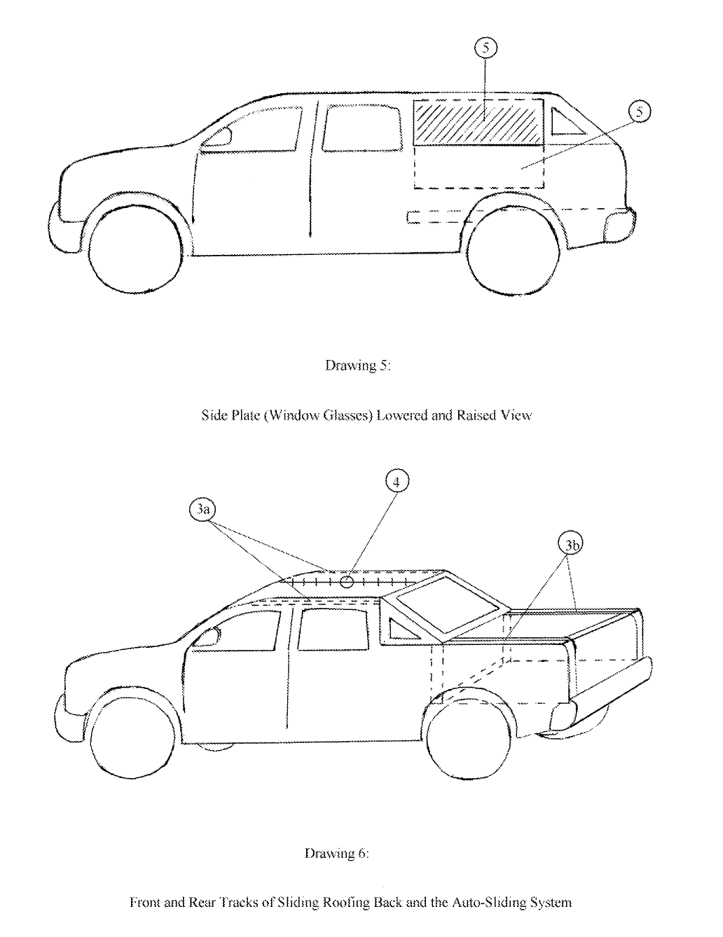

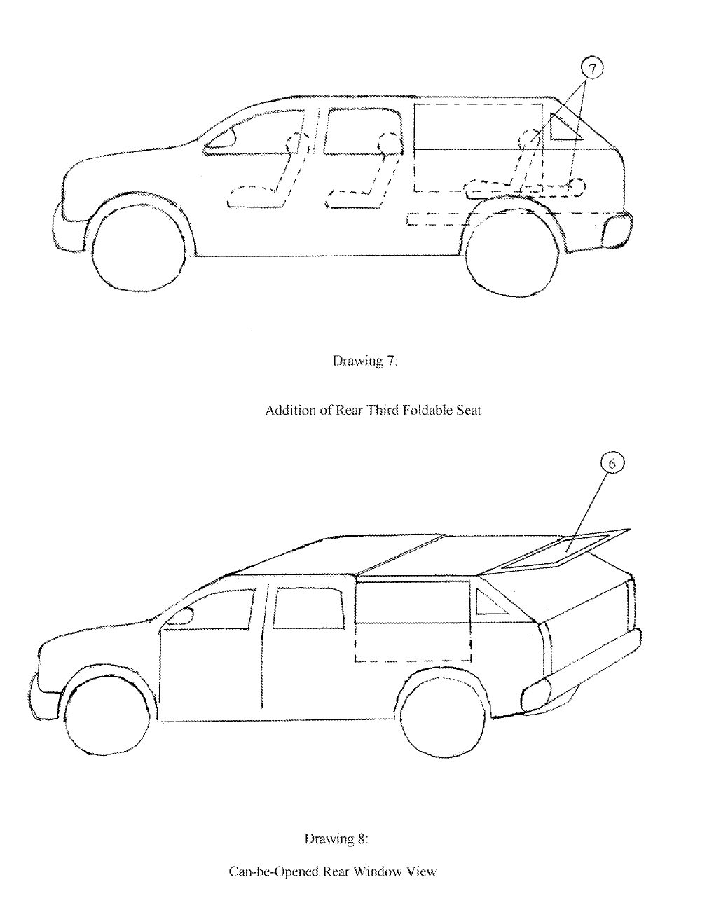

### TECHNICAL FIELD AND INDUSTRIAL APPLICABILITY

This invention falls into the auto design field and involves a novel concept and revolutionary design of vehicle body structure reform. It combines the structures, shapes and functions of both pickup trucks and SUVs, and therefore has very wide applicability in auto industry and auto market.

### BACKGROUND

The contemporary pickup truck is designed for picking up cargos, materials, towing a trailer and so on. Except for this main purpose, most of the time it is used only as a passenger car. Nowadays, therefore, backseat addition with four doors design for accommodating more passengers becomes more popular.

On the other hand, a SUV is primarily designed for driving in mountains and rough road conditions. With higher chassis underneath it is similar to a pickup truck's structure. Based on their similarities and differences, I have here designed a new vehicle which combines functions, shapes, and characteristics of both vehicles. I would name it SuperV: a New Combination Vehicle of a Pickup and SUV.

The purpose of the design is to combine the features of both vehicles, to accommodate the needs of either pickup or SUV drivers, for people who do not want to own a second vehicle but can enjoy the benefit and advantage of both vehicles, and therefore to save the energy and protect the environment.

### DESCRIPTION

The SuperV is derived from a standard pickup, and merges it into a SUV. There is an extendable roofing back that is hidden under the pickup roof at normal pickup condition and is slided out to form a SUV as needed.

The new design includes four major parts (see Drawings 1,2,5,6): sliding roofing back, foldable middle plate, side window glasses, and auto sliding track system.

The sliding roofing back is hidden under the pickup roof and forming the normal pickup driving chamber back when in pickup truck position. The foldable middle plate is in upright position to form the lower back of the driving chamber. At this form, it is considered a normal pickup with two rows of seats in driving chamber (Drawings 1,3).

The sliding roofing back is slided out and extended to the back end of the trunk, and meets with the pickup's back plate. The side window glasses are raised up to meet the roofing part and seal the gaps. It is considered a SUV at this form (Drawings 2,4).

The two functional position and shape changes let the vehicle shift between either a normal pickup or a SUV, Thus, it accommodates the needs for either vehicles. More importantly, by combining the benefits of both vehicles, it saves money, space and energy, and therefore protects the environment.

### DRAWINGS

Drawing 1: Pickup Performance Side View (middle-plate raised)

Drawing 2: SUV Performance Side View (middle-plate flattened)

Drawing 3: Pickup Performance Up-Side View

Drawing 4: SUV Performance Up-Side View

Drawing 5: Side Plate (Window Glasses) Lowered and Raised View

Drawing 6: Front and Rear Tracks of Sliding Roofing Back and the Auto-Sliding System

Drawing 7: Addition of Rear Third Foldable Seat

Drawing 8: Can-be-Opened Rear Window View

### SPECIFICATIONS

### Specification 1

Performed as a pickup: The sliding-roofing-back 1 is hidden under the pickup roof and forming a normal back of the pickup cab (driving chamber). The sliding-roofing-back can be divided into two portions: one is front top portion which forms roof part. This portion is in the same shape as the truck cab roof but is slided hidden under the roof, where between the two roofs are special roof-slide-tracks 3a in each side. The other is rear portion which forms the back part of the pickup's driving chamber. The foldable middle plate 2 is erected in upright position and meets the back part of the roofing back to from the lower back of the cab. At this performance, the vehicle forms a normal pickup truck, normally with two row seats in driving chamber (see Drawings 1,3).

### Specification 2

Performed as a SUV: The sliding-roofing-back is slided out and extended along the trunk-slide-tracks 3b to the back end of the trunk, where it meets the erected back plate of the trunk, and is also locked at the contact point with an auto-click-lock design. It is better designed with an auto-slide-gearwheel system 4 which extends and retracts the sliding-roofing-back automatically. The side-glass (side window glass) 5, which are hided inside trunk side plates as normal car window glass do, are raised up to meet the top and front portion of the sliding-roofing-back and therefore seal the gaps. At this performance, the vehicle forms a SUV (see Drawings 2,4).

The two performances of position and shape changes let the vehicle shift between either a normal pickup or a SUV functionally, and therefore accommodates the needs for either vehicle drivers.

### Several Design Features

1. Two row seats requirement. As described above, in driving chamber, there should be front seats of driver seat and passenger seat, and back seat sitting 2-3 passengers which can be designed foldable forward or backward (Drawing 7). This requirement is to make the cab roof compatible with the roofing part of the sliding-roofing-back.

2. Track system and auto-slide-gearwheel system. The track system consists of roof-slide-tracks 3a and trunk-slide-tracks 3b. The former is located under the cab roof on both sides, and the latter is located on top of both side trunk plates (Drawing 6). The auto-slide-gearwheel system 4 is located between the cab roof and sliding-roofing-back roof and consists of motor, gears, and moving track (Drawing 6). The two systems work together to extend or retract the sliding-roofing-back automatically.

3. The foldable middle plate 2, (or called trunk front plate according to its location). The plate works as both the lower cab back and front plate of the trunk (Drawings 1,2). It can be folded forward (or backward as desired) so the cab can be open to the trunk when the vehicle is in performance as a SUV.

4. Foldable third seat 7. The seat could be added in the middle of the trunk (Drawing 7). It should be laid down flat for loading cargos, or set upright for sitting passengers.

5. The back window 6 of the sliding-roofing-back should be designed open-able (Drawings 8). This design is to accommodate the needs of loading a bigger or longer cargo.

6. The side-glass (side window glass) 5, and height of trunk side plate. The side-glass is located hidden inside both trunk side plates and designed as the same as normal car power window does. It is raised up to close the space between the trunk side plate and the top and front portions of the sliding-roofing-back when the vehicle is in performance as a SUV (Drawing 5). The trunk plate height is compatible with the height of the glass accordingly.

What is claimed is:

1. A new combination vehicle of pickup and SUV which comprising four major parts: sliding roofing back, foldable middle plate, side window glasses, and auto sliding track system; wherein said four parts make the vehicle convertible from either pickup truck to SUV or vice versa by changing their performances.

2. A new combination vehicle of pickup and SUV of claim 1, wherein said the sliding roofing back is hidden under the cab roof and forming the normal pickup back when in performance of a pickup truck, with the foldable middle plate in upright position to form the lower back of the cab (driving chamber).

3. A new combination vehicle of pickup and SUV of claim 1, wherein said the sliding roofing back is slided out and extended to the back end of the trunk, and meets with the pickup's back plate, while side window glasses are raised up to meet the roofing part of the sliding-roofing-back and seal the gaps.

4. A new combination vehicle of pickup and SUV of claim 1, wherein said a foldable third seat is added in the middle of the trunk, and it is laid down flat for loading cargos with middle plate erected, or set upright for sitting passengers with middle plate folded down.
